(19) United States
(12) Patent Application Publication
(10) Pub. No.: US 2021/0163257 A1
(43) Pub. Date: Jun. 3, 2021

(54) Method Of Operating An Elevator System By The Specification Of A Predetermined Travel Route, an Elevator System, and an Elevator Controller For Carrying Out Such A Method

(71) Applicant: TK Elevator Innovation and Operations GmbH, Essen (DE)

(72) Inventor: Matthias Glück, Hochdorf (DE)

(73) Assignee: TK Elevator Innovation and Operations GmbH, Essen (DE)

(21) Appl. No.: 17/250,636

(22) PCT Filed: Aug. 1, 2019
(86) PCT No.: PCT/EP2019/070787

§ 371 Date: Feb. 14, 2021

(30) Foreign Application Priority Data
Aug. 13, 2018 (DE) 102018213575.4

(51) Int. Cl. B66B 1/24

(52) U.S. Cl. CPC B66B 1/2458; B66B 2201/23; B66B 2201/213

(57) ABSTRACT

Disclosed is a method of operating an elevator system having a plurality of elevator cars that are simultaneously and individually moveable in an elevator shaft between a plurality of floors. A predetermined travel route is assigned to an elevator car or a plurality of elevator cars. This travel route is defined by a sequence of stopping points that is fixed in advance for the respective elevator car and at which stopping points the respective elevator car is intended to make a planned stop. The elevator cars to which a travel route is assigned are then moved in accordance with the travel route assigned to the respective elevator car. Further disclosed is an elevator controller and to an elevator system for carrying out such a method.

The invention relates to a method for operating an elevator system, wherein the elevator system comprises a plurality of elevator cars which can move individually between a plurality of floors. Here, a plurality of elevator cars of the elevator system can be moved simultaneously in an elevator shaft of the elevator system.

Moreover, the invention relates to an elevator controller and to an elevator system for carrying out such a method.

Such elevator systems are known in particular as ropeless multicabin elevator systems having a plurality of horizontal and vertical elevator shafts. Here, the elevator cars of such an elevator system are largely moved independently of one another in particular by means of a linear motor drive. The operation of such an elevator system, in particular with regard to efficient movement of the elevator cars in the elevator shafts of the elevator system, represents a major challenge here. Operating such elevator systems frequently calls upon the use of destination call controllers at which elevator users specify the desired destination floor while already outside of the elevator car. This helps to better allocate the elevator cars to the calls made. However, particularly as a result of individual travel requests on the part of the elevator users, it is frequently the case here that only few persons can use the same elevator car.

Moreover, during the operation of such an elevator system, it must frequently already be taken into consideration that elevator cars following one another in succession may not arbitrarily draw closer to one another. This is because, to prevent collisions between the elevator cars, there must always be maintained a minimum distance between successively following elevator cars. Furthermore, such elevator systems having vertical and horizontal elevator shafts customarily comprise shaft change units in order that an elevator car can change from a first elevator shaft into a second elevator shaft. It also has to be taken into consideration here during the operation of such an elevator system that, on the one hand, only one elevator car can as a rule use one shaft change unit.

Moreover, the greater expenditure of time associated with the shaft change has to be taken into consideration.

Since, moreover, elevator users frequently have little experience in the correct operation of such elevator systems, faulty operations also frequently occur, such as incorrect inputting of the destination floor or the fact that not all of the elevator users make a call.

In order to take all these aspects into consideration during the operation of such an elevator system, evermore complex algorithms for the operation of the elevator systems are being developed. The use of more complex algorithms can lead here to the operating and use complexity also increasing on the user side, with the result that the number of errors occurring when operating the elevator system can also increase.

Against this background, it is an object of the present invention to improve the operation of an elevator system. In particular, the calculation of the state of the elevator system is intended to be simplified. Advantageously, the conveying capacity of an elevator system having a plurality of elevator cars is intended to be improved and, also advantageously, the actual conveying capacity is intended to be able to be better calculated and better planned.

To achieve this object there are proposed a method for operating an elevator system having a plurality of elevator cars which can move individually between a plurality of floors, and an elevator controller and an elevator system as claimed in the independent claims. Further advantageous embodiments of the invention are described in the dependent claims and the description. Further advantages and features will also emerge from the exemplary embodiments illustrated in the figures.

The proposed solution provides a method for operating an elevator system having a plurality of elevator cars which can move individually between a plurality of floors, wherein a plurality of elevator cars can be moved simultaneously in an elevator shaft of the elevator system, in particular can be moved laterally and vertically. Here, a predetermined travel route is assigned to at least one elevator car from the plurality of the elevator cars of the elevator system, in particular to a plurality of elevator cars of the elevator system or to all elevator cars of the elevator system. Here, the travel route assigned to the at least one elevator car of the elevator system is defined by a sequence of stopping points that is fixed in advance for this at least one elevator car, wherein the at least one elevator car is intended to make a planned stop at each of these stopping points. Here, the stopping points are in particular predetermined stopping locations at which elevator users can enter and/or exit the elevator car. Here, the at least one elevator car is moved in accordance with the travel route assigned to this at least one elevator car. The at least one elevator car thus advantageously travels to the predetermined stopping points sequentially in each case. It is possible here in particular for different travel routes to be assigned to elevator cars of the elevator system. Thus, one embodiment variant can in particular provide for an individual travel route to be assigned in each case to each elevator car of the elevator system, wherein the travel routes respectively assigned to the elevator cars can differ in terms of the sequence of stopping points. In particular, there is provision that the travel route comprises a start stopping point and an end stopping point. Furthermore, there is provision in particular that the elevator car, after reaching the end stopping point, is moved back to the start stopping point and is moved again in accordance with the travel route. The start stopping point and end stopping point of the travel route are advantageously identical.

The assignment of travel routes to the elevator cars advantageously reduces the control complexity for the allocation of elevator cars to calls made by elevator users. Thus, there is provision in particular that those elevator cars of the elevator system to which a travel route is assigned are moved exclusively in accordance with this assigned travel route and individual calls made by elevator users remain unconsidered.

The elevator cars of the elevator system to which a travel route is assigned are thus advantageously moved not on the basis of individually made calls of elevator users, but rather according to a predetermined travel plan. In particular, there is provision that a predetermined travel route is assigned to the at least one elevator car, wherein the stopping points of the travel route are not directly defined on the basis of calls for one of these stopping points that are received on the part of the elevator system.

In particular, one advantageous embodiment provides for a predetermined travel route to be assigned in each case to all elevator cars of the elevator system. In this case, there is provision in particular that the elevator system comprises no means for call inputting for normal elevator operation. There can thus indeed be provision that the elevator system, in special operating modes, for example in the event of a fire, still continues to comprise operating elements, for example a closing circuit, in order to steer an elevator car into a floor in a targeted manner and thus override the travel route. However, for normal operation, there is in particular provision here that the elevator system has no operating means for call inputting, that is to say in particular no destination call terminal or input means in the elevator cars for making an internal call. As a result, the control complexity for the operation of the elevator system is advantageously greatly simplified. In particular, there can also be provision that operating means are deactivated, in particular are deactivated for control-related reasons. Here, the operating means are advantageously then deactivated for elevator cars to which a travel route is assigned. Particularly if the allocation of a travel route to an elevator car occurs only temporarily, the deactivation of the operating means advantageously also occurs only for this time period. A deactivation of the operating means is advantageously accordingly signaled to the elevator users.

In particular, there can also be provision that the travel route is predetermined by some few stopping points, advantageously at some few stopping points at which, however, many elevator users enter and/or exit an elevator car. Such highly frequented stopping points can be, for example, one or more of the following stated floors: ground floor; parking deck; floor with canteen; floor with businesses; floor with many offices. These stopping points are traveled to by the elevator car in each case, irrespective of whether a call has been received for this floor. On other floors which are not defined as stopping point of the travel route, an elevator car of the elevator system advantageously only stops when a call for this floor has been made and received by the elevator system.

In particular, one advantageous embodiment of the invention provides for the elevator system to comprise a plurality of elevator shafts and/or shaft systems. There is in particular provision here that a predetermined travel route is assigned to elevator cars in a subset of these shafts, wherein the travel route is advantageously defined in such a way that a planned stop by the respective elevator car is made exclusively at each nth floor, for example at each 5th floor, where n is a whole rational number. There can be provision here that the intermediate floors then have to be reached particularly via stairways, escalators or local elevators.

In particular, there can be provision that the at least one elevator car is moved in a circulating operation.

A further advantageous embodiment of the invention provides for the travel route assigned to the at least one elevator car to comprise a start stopping point, from which the travel route of the at least one elevator car begins, and an end stopping point, at which the travel route of the at least one elevator car ends, wherein a defined time interval is predetermined for the movement of the at least one elevator car from the start stopping point to the end stopping point, and the at least one elevator car is moved in such a way that this at least one elevator car is moved from the start stopping point to the end stopping point within the predetermined time interval. In particular, there is provision that this at least one elevator car is moved from the start stopping point to the end stopping point exactly following the expiry of the predetermined time interval. Here too, the start stopping point and end stopping point can be defined in an identical manner. This embodiment has the advantageous effect that the at least one elevator car is moved in accordance with the travel route after fixed time intervals. In this embodiment, it is advantageous that no fixed times or time intervals are predetermined for the predetermined intermediate stops between the start stopping point and the end stopping point, and therefore a longer stop can be made when required at one stopping point of the sequence of stopping points, for example because many persons enter there, and a shorter stop can be made at another stopping point of the sequence of stopping points, for example because no persons wish to enter and/or exit there. In order to ensure that the predetermined time interval for running through the predetermined sequence of stopping points can be observed even under heavy operation, there is provision in particular that the elevator system comprises corresponding means, such as in particular a so-called crowding function and forced closing of the doors, which prevent retention of an elevator car at a stopping location.

According to a further advantageous embodiment of the invention, at least for a first stopping point from the sequence of stopping points, a number of time points are predetermined at which the at least one elevator car makes a planned stop recurrently at this first stopping point. These time points can be relative time points, that is to say in particular predetermined time intervals, or absolute time points, that is to say in particular fixedly predetermined times of day. Such a number of time points are preferably predetermined for each stopping point from the sequence of stopping points. For the elevator cars to which a travel route is assigned, it is thus advantageously defined at which time points they make a stop at which stopping points. This advantageously improves the ability to calculate the state of the elevator system, in particular the ability to calculate the behavior and the expected conveying capacity of the elevator system. Moreover, it is advantageously ensured that an elevator car will make a planned stop at a stopping point at the latest after the expiry of the time interval resulting from the predetermined time points.

For example, there can be provision that an elevator car of the elevator system is assigned a travel route that provides for the elevator car, beginning around 9:00 and ending around 18:00, to travel every six minutes to the ground floor as a stopping point of the travel route. For the ground floor as stopping point from the sequence of stopping points, there is thus predetermined a corresponding number of time points, that is to say in this example 9:00, 9:06, 9:12, 9:18, . . . , 20:54, 21:00, at which the elevator car makes a planned stop recurrently on the ground floor. Elevator users can advantageously prepare for an elevator car to stop at this stopping point at these time points.

The predetermined travel route is advantageously assigned to at least two elevator cars of the elevator system, wherein the at least two elevator cars make a planned stop at the stopping points of the travel route at respectively different time points. The transport capacity along the respective travel route is thereby advantageously increased. The travel routes which are assigned to the at least two elevator cars can in particular also only partially correspond, in particular only in terms of a subset of the stopping points of the respective fixed sequence of stopping points.

In particular, at least one first elevator car and at least one second elevator car are provided as the at least one elevator car of the elevator system, wherein, as travel route, a first travel route is assigned to the at least one first elevator car and, as travel route, a second travel route is assigned to the at least one second elevator car, wherein the first travel route is different than the second travel route in terms of the sequence of the stopping points. That is thus to say in particular that different travel routes can be assigned to elevator cars of the elevator system. There is thus in particular provided one embodiment in which only a single travel route exists that is assigned to one or more or all elevator cars of the elevator system. However, as a preferred embodiment, there is in particular provision that a plurality of predetermined, different travel routes exist, wherein these travel routes are assigned to the elevator cars of the elevator system, in particular in such a way that a first travel route is assigned to a first group of elevator cars and a second travel route is assigned to a second group of elevator cars and an nth travel route is assigned to an nth group of elevator cars, where n is a whole rational number.

A minimum time interval is advantageously predetermined which lies between the time points at which one elevator car of the at least two elevator cars makes a planned stop at a stopping point from the sequence of the stopping points and an elevator car, which follows this elevator car, of the at least two elevator cars makes a planned stop at this same stopping point. This advantageously reduces the probability that these two elevator cars impede one another and thus also reduces the occurrence of the so-called “bunching” effect. In particular, there can be provision that at least ten seconds lie between the at least two elevator cars making a stop at a stopping point. The specification of this time interval can in particular be determined in dependence on the required transport capacity at the stopping point and/or along the travel route of the at least two elevator cars. The time interval for a high required transport capacity is thus advantageously less than for a required low transport capacity.

According to a further advantageous development of the invention, for each of the at least two elevator cars, there is in each case predetermined for each stopping point of the sequence of stopping points a time point at which the at least two elevator cars each make a planned stop at the respective stopping point.

With regard to the aforementioned example, there is thus in particular provision that a travel route is assigned to further elevator cars of the elevator system, wherein these travel routes at least also comprise the ground floor as stopping point. It is advantageous for, for example, eight elevator cars to be respectively assigned a travel route, each of which travel routes comprises the ground floor as stopping point for a planned stop of the respective elevator car. Here, the time points for a planned stop of the respective elevator car can lie differently far apart or else lie apart to the same degree. If the time points can lie apart to the same degree, there can be provision for example that a first elevator car stops on the ground floor around 9:00:00, a second elevator car around 9:00:45, a third elevator car around 9:01:30, a fourth elevator car around 9:02:15, a fifth elevator car around 9:03:00, a sixth elevator car around 9:03:45, a seventh elevator car around 9:04:30, an eighth elevator car around 9:05:15 and then the first elevator car again around 9:06:00, etc. In particular, the travel routes of the eight elevator cars can here be identical with respect to the predetermined stopping points. However, there can in particular also be provision that, starting from the ground floor, the first elevator car, the third elevator car, the fifth elevator car and the seventh elevator car have each been assigned the even floors as stopping points, and the second elevator car, the fourth elevator car, the sixth elevator car and the eighth elevator car have each been assigned the odd floors as stopping points.

According to a further advantageous embodiment of the invention, travel requests of elevator users are detected, in particular by means of detecting the calls made or by means of sensors, such as for example cameras, and the detected travel requests are evaluated, in particular on the part of an elevator controller. Here, the number of the elevator cars to which the travel route is assigned is advantageously determined in dependence on the result of the evaluation of the travel requests. That is to say that, in this embodiment, there is in particular provision that elevator users can continue to make calls, in particular destination calls, at the floors. However, unlike in a conventional method for operating an elevator system, it is the case here that an elevator car is not assigned to the individual calls, but rather the calls made are ascertained to determine a conveying requirement along an already predetermined travel route. If it is ascertained here, for example on the basis of the number of calls received by the elevator system, that the conveying requirement has increased in relation to an earlier time point, the predetermined travel route is advantageously assigned to at least one further elevator car of the elevator system, and this at least one further elevator car will move along the predetermined travel route. Such a requirement increase can arise for example in an office building at the end of the working day when many persons are making their way home. If, on the other hand, the conveying requirement along a travel route is reduced in comparison to an earlier time point, for example because fewer persons remain in a building in the evening, there is provision in particular that the number of those elevator cars which are moved in accordance with the travel route is reduced. In particular, there is provision that, as travel requests, there are taken into consideration the number of the calls received by the elevator system and/or the starting floors from which calls are made, and/or the destination floors to which elevator users wish to be conveyed. In particular, there is provision that, in the event of a conveying requirement along a travel route falling below a predetermined limit value, the operation of the elevator system is switched to conventional call making, at least until the conveying requirement lies above the limit value again.

Here, elevator cars of the elevator system to which no travel route is assigned can in particular be held available in a depot region or an unused shaft region, in particular until they are used on account of an increased conveying requirement. Alternatively or additionally, there is in particular provision that those elevator cars of the elevator system to which no travel route is assigned are used as required, that is to say react in particular to calls made by elevator users and attend these calls. Here, during the movement of those elevator cars to which no travel route is allocated, it is advantageous for the movement paths of the elevator cars to which a travel route is assigned to be taken into consideration. Since these travel routes are advantageously defined, being advantageously defined both with respect to position and with respect to time point, taking these movement paths into consideration can advantageously be implemented in a simple manner.

A further advantageous embodiment provides for travel requests of elevator users to be detected and for the detected travel requests to be evaluated. It is advantageously the case here that the travel route assigned to the at least one elevator car is adapted in dependence on the result of the evaluation. In this embodiment, too, there is provision that the predetermined travel route is not based directly on calls received by the elevator system. Instead, a travel route is predetermined, although there can be provision to adapt this travel route to an actual conveying requirement. In particular, there is provision here that stopping points from which no calls are made over a specified time period are omitted from the travel route. In particular, there is additionally provision that other stopping points from which an increased number of calls are made are included in the travel route. Furthermore, there is provision in particular that the stopping points of a travel route assigned to an elevator car of the elevator system lie comparatively far apart, for example at least ten floors, more particularly fifteen floors, wherein the elevator cars between the predetermined stopping points can advantageously react to calls made and make a stop at further stopping points than the stopping points predetermined by the travel route, in order to allow elevator users to enter the elevator car and/or to allow elevator users to exit the elevator car. Here, the travel route can be adapted in particular in such a way that a reaction is made directly to a call received by the elevator system by establishing from which floor a conveying request arises and by the elevator car making an additional stop on this floor, in particular without this stop being added as a fixed stopping point of the travel route. It is preferably ascertained from which building regions many calls are made, and a further stop is made by the elevator car at a specific floor within this building region. If, for example, it is detected that a high number of calls are made from floors 23 to 27, with none of these floors being assigned a predetermined stopping point of the travel route, there is provision in particular that floor 25 is added as a further stopping point of the travel route. It is advantageously the case here that floors 23 to 27 are given a corresponding indication that floor 25 is being approached by the elevator car. There is advantageously provided an additional indication as to the time point at which the elevator car stops at floor 25. If the number of the calls made from floors 23 to 27 is permanently high, there is provision in particular that, at least for the duration of the high number of calls made, floor 25 is added to the sequence of stopping points that is fixed in advance.

A further advantageous embodiment of the invention provides for the travel route assigned to the at least one elevator car to be assigned to the at least one elevator car in dependence on at least one event. In particular, this embodiment provides for the travel route assigned to the at least one elevator car to be assigned to the at least one elevator car in dependence on at least one of the following stated events: event in the building; day of the week; behavior of the persons in the building; weather; time of the year; local public transport departure/arrival times; time of the day. In particular, there is provision here that a plurality of travel routes are predetermined. These travel routes are here advantageously already linked in advance with the occurrence of certain events. If, for example, an event takes place in a part of the building, it is advantageous for at least one elevator car of the elevator system to have a travel route assigned to it that comprises at least one stopping point in the corresponding part of the building in which the event takes place.

A particularly preferred embodiment of the invention provides for the travel route assigned to the at least one elevator car to be displayed by means of at least one display device. It is advantageously the case here that display devices, in particular displays, are arranged on all floors of the building. On these display devices there are here advantageously displayed all the travel routes along which elevator cars of the elevator system are moved. In particular, there is provision here that, in addition to the travel routes, the times are specified at which an elevator car will make a stop at a respective stopping point of the travel route. According to one advantageous development, there is provision here that different design features are assigned to the different travel routes, in particular different colors, with advantageously the different design features being picked up by corresponding signaling upon arrival of an elevator car on a floor level. If, for example, a first travel route along which a plurality of elevator cars are moved is allocated the color yellow, and a second travel route along which a plurality of further elevator cars are moved is assigned the color blue, the color yellow lights up on a floor level upon arrival of an elevator car to which the first travel route is assigned, and the color blue lights up upon arrival of an elevator car to which the second travel route is assigned.

A further advantageous embodiment provides for an elevator user, instead of a conventional call input on a floor, in particular instead of a destination call, to select the travel route along which the elevator user wishes to be transported. With reference to the aforementioned example, there can in particular be provision here that the elevator user who wishes to be transported along the first travel route actuates a yellow input element, whereas a user who wishes to be transported along the second travel route actuates a blue input element. According to a further advantageous embodiment, the elevator user inputs his destination floor here in the elevator car. It is advantageously the case here that the elevator car provides an indication of a necessary elevator car change if the destination floor is not directly traveled to by the elevator car in which the elevator user is situated.

A further advantageous embodiment of the invention provides that, as travel route, a first travel route is assigned to at least one first elevator car of the elevator system and, as travel route, a second travel route is assigned to at least one second elevator car of the elevator system, wherein the first travel route is different than the second travel route in terms of the sequence of the stopping points. It is advantageously the case here that the first travel route is temporarily assigned to the at least one second elevator car such that, with respect to the at least one second elevator car, a change of the assignment from the second travel route to the first travel route occurs. This embodiment is particularly advantageous when a travel route is assigned to all elevator cars of the elevator system, and there is an increased conveying requirement on a travel route, in particular an increased conveying requirement on account of the time of day. An elevator car which is moved along a less highly requested travel route is then advantageously temporarily assigned another travel route along which there is an acute high conveying requirement. That is to say that a standard travel route and in addition a requirement travel route are advantageously allocated to a subset of elevator cars of the elevator system, wherein the subset of elevator cars is as a rule moved along the standard travel route, but the requirement route, instead of the standard travel route, is temporarily allocated to the subset of elevator cars in the case of a high travel density on the requirement travel route, with the result that the subset of elevator cars is temporarily moved along the requirement route.

A further advantageous embodiment provides that, for at least one third elevator car from the plurality of the elevator cars of the elevator system, a travel path is continuously determined and updated on the basis of call requests received by the elevator system. It is advantageously the case here that this travel path is not a predetermined travel route, but a travel path which is determined in a conventional manner dependent on requirement. That is to say there is in particular provision that the elevator system comprises a first group of elevator cars which is moved along a first predetermined travel route, the elevator system comprises a second group of elevator cars which is moved along a second predetermined travel route, and the elevator system comprises a third group of elevator cars to which no predetermined travel route is assigned, but the travel paths thereof result on the basis of calls currently received by the elevator system.

To achieve the object stated at the outset, there is also proposed an elevator controller which is designed to carry out the method steps of a method proposed according to the invention. Here, the elevator controller can be formed centrally or decentrally. In particular, there is provision that the elevator controller comprises storage regions in which the at least one travel route is stored. In particular, there is further provision that the elevator controller comprises means for allocating travel routes to elevator cars. Furthermore, the elevator controller advantageously comprises at least one interface via which travel requests of elevator users are detected. Further advantageously, the elevator controller comprises at least one evaluation unit, in particular for evaluating travel requests of elevator users. In particular, the elevator controller moreover comprises means to control the movement of the elevator cars of the elevator system, in particular along the travel routes assigned to these elevator cars and in particular while taking further conditions into consideration, such as for example taking into consideration predetermined time points for an elevator car to make a planned stop.

To achieve the object stated at the outset, there is further proposed an elevator system which is designed to carry out a method proposed according to the invention. Here, this elevator system comprises in particular a shaft system and a plurality of elevator cars which can move in the shaft system. In particular, there is provision that the elevator cars can here be moved horizontally and vertically in the shaft system. In particular, there is provision that the elevator system is a ropeless multicabin elevator system, in particular an elevator system comprising a linear motor drive for moving the elevator cars. Furthermore, there is in particular provision that the elevator system comprises an aforementioned elevator controller which is advantageously designed to carry out the method steps of a method proposed according to the invention.

Further advantageous details, features and embodiment details of the invention will be explained in more detail in conjunction with the exemplary embodiments illustrated in the figures, in which:

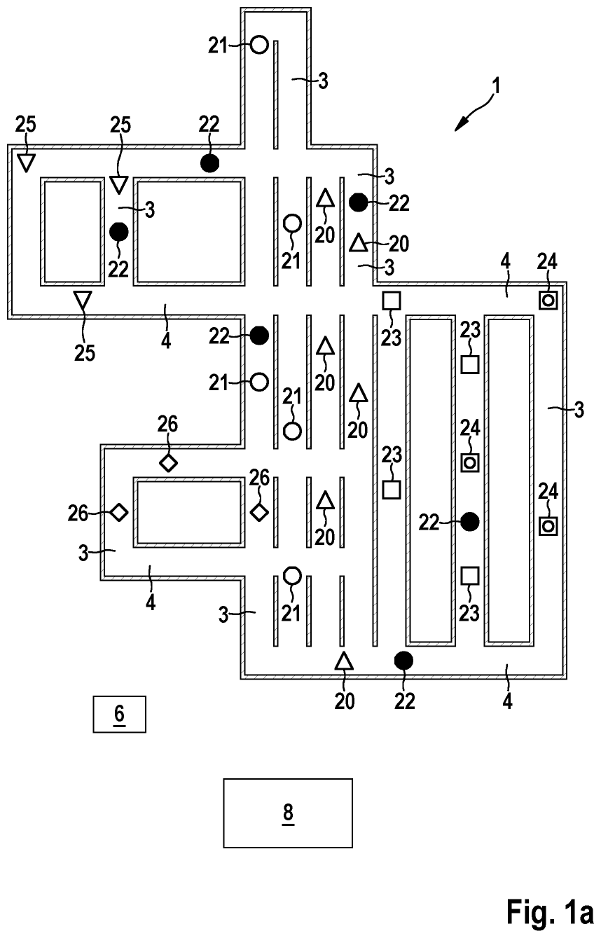

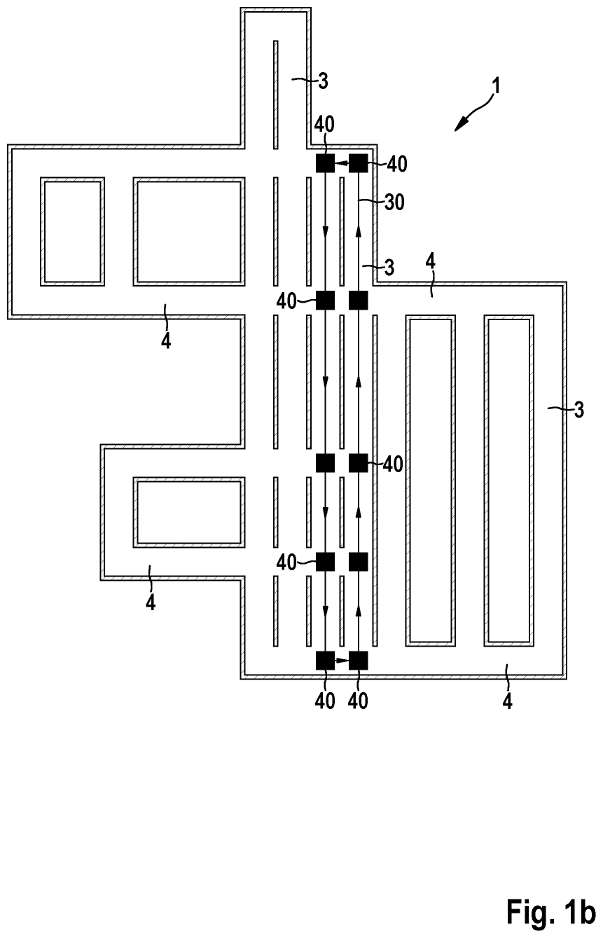

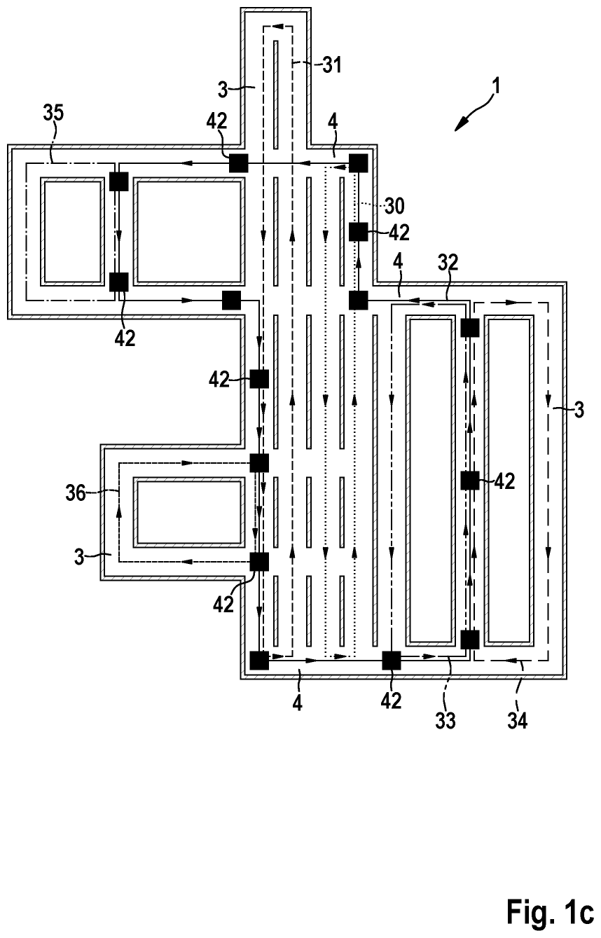

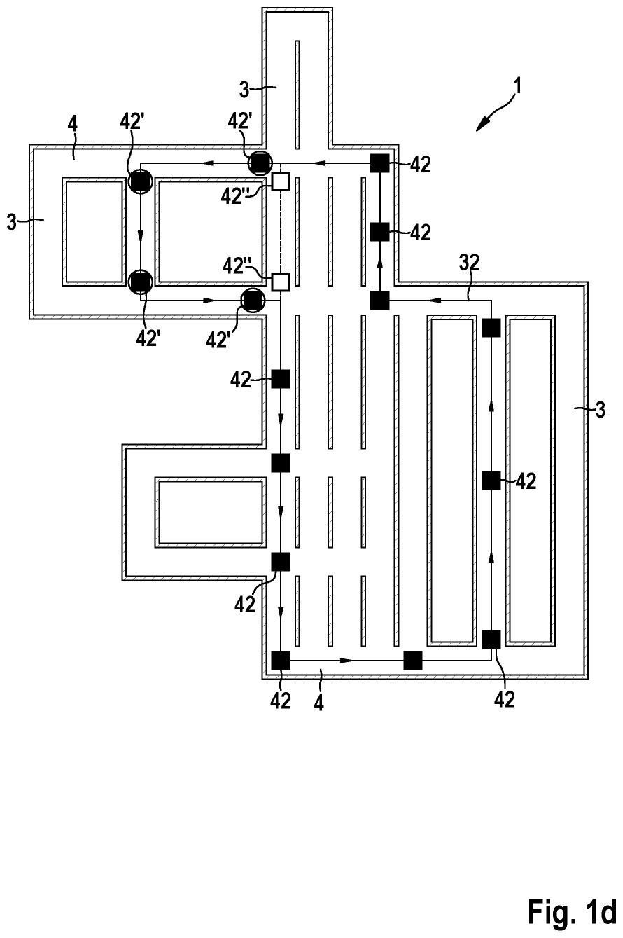

FIG. 1a is a simplified schematic illustration showing one exemplary embodiment of an elevator system according to the invention;

FIG. 1b is a simplified schematic illustration showing one exemplary embodiment of an operation according to the invention of an elevator system;

FIG. 1c is a simplified schematic illustration showing a further exemplary embodiment of an operation according to the invention of an elevator system;

FIG. 1d is a simplified schematic illustration showing a further exemplary embodiment of an operation according to the invention of an elevator system;

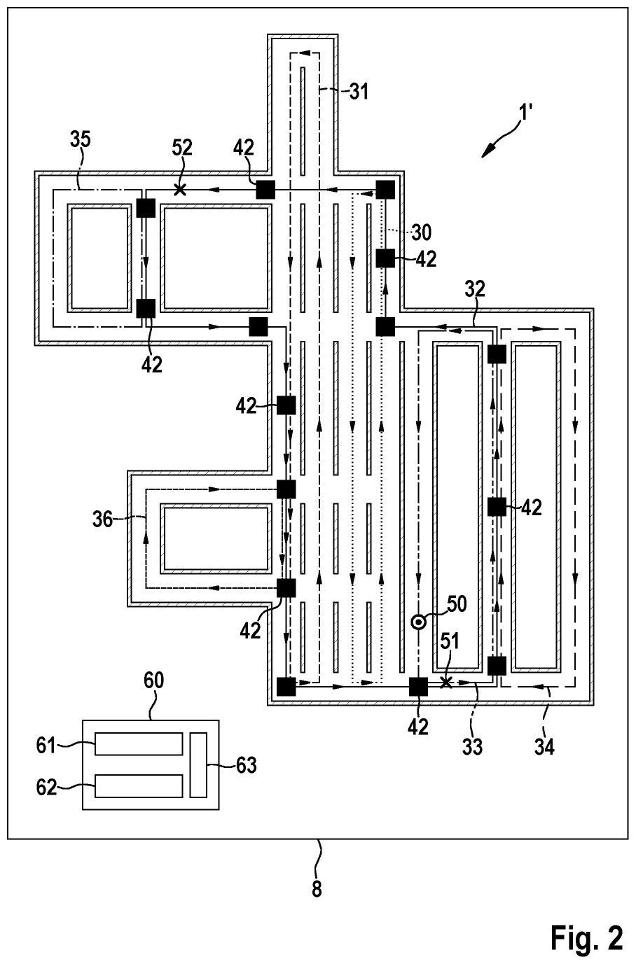

FIG. 2 is a simplified schematic illustration showing one exemplary embodiment of a display device of an elevator system according to the invention; and

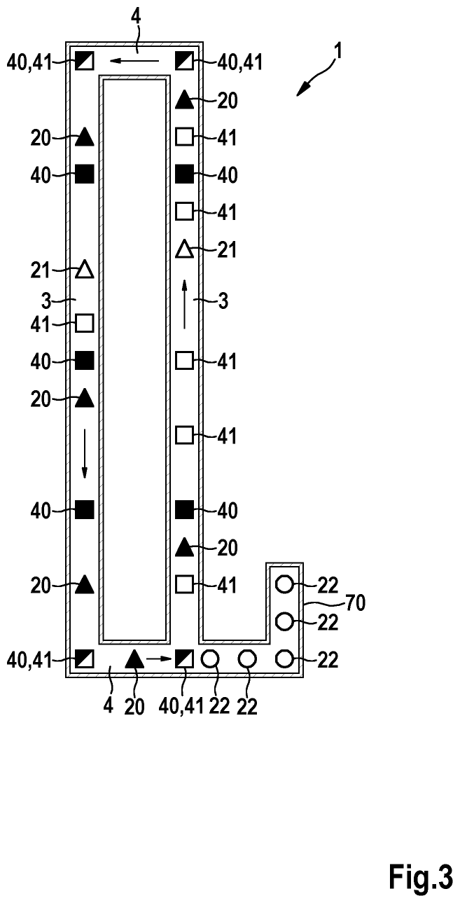

FIG. 3 is a schematic illustration showing a further exemplary embodiment of an elevator system according to the invention.

The elevator system 1 shown as exemplary embodiment in FIG. 1a comprises a shaft system having a plurality of vertical elevator shafts 3 and horizontal elevator shafts 4. Furthermore, the elevator system 1 comprises a plurality of elevator cars 20, 21, 22, 23, 24, 25, 26. Here, the elevator cars 20, 21, 22, 23, 24, 25, 26 of the elevator system 1 can be moved individually in the elevator shafts 3, 4. In particular, there is provision that the elevator cars 20, 21, 22, 23, 24, 25, 26 are moved in the elevator shafts 3, 4 by means of a linear motor drive system. Here, there is in particular provision that the elevator cars 20, 21, 22, 23, 24, 25, 26 can change from one elevator shaft 3, 4 into another elevator shaft 3, 4. For this purpose, there are provided in particular so-called shaft change units, which are not explicitly illustrated in FIG. 1a. Furthermore, the elevator system 1 comprises an elevator controller 6, which is symbolically illustrated in FIG. 1a. In particular, there is provision that the elevator controller 6 is designed as a decentral control system. It is the case here that in particular the movement of the elevator cars in the elevator shafts 3, 4 is controlled by means of the elevator controller 6. Furthermore, there can in particular be provision that the elevator controller 6 comprises at least one safety system (not explicitly illustrated in FIG. 1a), with this safety system in particular being configured to detect possible collision risks between elevator cars 20, 21, 22, 23, 24, 25, 26 and thus prevent situations in which a collision between elevator cars 20, 21, 22, 23, 24, 25, 26 could occur.

The elevator system 1 illustrated in FIG. 1a is operated in such a way that a predetermined travel route is assigned to at least one elevator car 20, 21, 22, 23, 24, 25, 26 of the elevator system 1, in particular to a first group of elevator cars 20, 21, 22, 23, 24, 25, 26. This predetermined travel route is here defined by a sequence of stopping points that is fixed in advance and at which stopping points the at least one elevator car 20, 21, 22, 23, 24, 25, 26 makes a planned stop. Here, the at least one elevator car 20, 21, 22, 23, 24, 25, 26 is moved in accordance with the travel route assigned to this elevator car 20, 21, 22, 23, 24, 25, 26. In particular, the assignment of a travel route to an elevator car 20, 21, 22, 23, 24, 25, 26 is explained in more detail below here with reference to FIG. 1b, FIG. 1c and FIG. 1d.

Thus, for example, FIG. 1b illustrates the case in which a travel route 30 is assigned exclusively to the elevator cars 20 of the elevator system 1 illustrated in FIG. 1a. This travel route 30 is here defined by a sequence of stopping points 40 that is fixed in advance and at which stopping points the elevator cars 20 each make a planned stop. Here, the stopping points 40 are each situated on a floor level at which it is possible for elevator users to enter and/or exit the respective elevator car 20. In this exemplary embodiment, the stopping points 40 are moreover fixed in such a way that the elevator cars 20 are moved in a circulating operation. The direction of travel of the elevator cars 20 is symbolically illustrated here by means of arrows.

In this exemplary embodiment, there is moreover provision that the further elevator cars 21, 22, 23, 24, 25, 26 illustrated in FIG. 1a are moved in a conventional manner, that is to say no travel routes are assigned to these elevator cars 21, 22, 23, 24, 25, 26 in this exemplary embodiment. Instead, these elevator cars 21, 22, 23, 24, 25, 26 react to calls which are received by the elevator system 1 or the elevator controller 6 and which are made in particular by elevator users via corresponding input terminals. For the elevator cars 21, 22, 23, 24, 25, 26, it is thus the case that—unlike for the elevator cars 20—a travel path is continuously determined and updated on the basis of call requests received by the elevator system.

This stipulation that, in the exemplary embodiment illustrated in FIG. 1b, a travel route 30 is assigned only to the elevator cars 20 is particularly advantageous when a less high traffic volume is expected in the other parts of the building, with the result that the movement of elevator cars along a fixedly predetermined travel route is less advantageous in these other parts of the building. In the specific exemplary embodiment, it is moreover advantageous that all floors which are traveled to by the elevator cars 20 can also be traveled to by the elevator cars 21 via the parallel elevator shafts, wherein, in the present exemplary embodiment, the movement of the elevator cars 21 is controlled by corresponding call making, in particular the making of destination calls.

In the exemplary embodiment illustrated in FIG. 1b, the stopping points 40 of the travel route 30 are moreover advantageously fixed in such a way that it is possible from these stopping points 40 to carry out a simple change to other shafts in which the further elevator cars 21, 22, 23, 24, 25, 26 are moved, in particular to allow an elevator user to reach the final destination floor with one of these elevator cars 21, 22, 23, 24, 25, 26. In the exemplary embodiment illustrated in FIG. 1b, there is in particular provision that the elevator cars 20 make a stop exclusively at the predetermined stopping points 40 and make no additional stops between these predetermined stopping points 40. However, it is possible in particular to provide an embodiment variant according to which the elevator users can specify a stop request, advantageously within a respective elevator car 20. Advantageously, the elevator car 20 will then move directly to a destination floor desired by an elevator user and make an intermediate stop between the predetermined stopping points 40. This intermediate stop advantageously occurs in dependence on the transport density to be conveyed and/or the distance from the preceding elevator car and/or the distance from the following elevator car. If, for example, the transport density at the predetermined stopping points 40 is greater than a predetermined limit value, there can be provision that no intermediate stops are allowed, likewise if it would not be possible to observe a predetermined time interval for running through the travel route 30 from the predetermined start stopping point to the predetermined end stopping point when making an intermediate stop or a further intermediate stop. Even when tailgating by the following elevator car is to be expected in the case of an intermediate stop or exceeding a predetermined distance from the preceding elevator car is to be expected, there can be provision that an intermediate stop is not allowed. An elevator user will advantageously be correspondingly informed within the elevator car.

However, in the exemplary embodiment illustrated with reference to FIG. 1a and FIG. 1b, this making of intermediate stops is not provided. This is because, in this exemplary embodiment, all floors which can be traveled to by the elevator cars 20 can also be served by the elevator cars 21. An elevator user thus has the choice of whether he wishes to travel with the elevator cars 21 or with the elevator cars 20. However, this decision can in particular also be determined by the elevator controller 6, in particular in dependence on the traffic volume.

In the exemplary embodiment explained with reference to FIG. 1a and FIG. 1b, there is in particular provision that the travel route 30 assigned to the elevator cars 20 comprises a start stopping point, for example the stopping point 40 illustrated at the bottom left in FIG. 1b, from which the travel route 30 of the elevator cars 20 begins. Furthermore, the travel route 30 comprises an end stopping point, at which the travel route 30 of the elevator cars 20 ends. The start stopping point and end stopping point can be the same in this exemplary embodiment, in particular since the elevator cars 20 are moved in circulating operation. Here, a defined time interval is predetermined, preferably by the elevator controller 6, for the movement of the elevator cars 20 from the start stopping point to the end stopping point. Here, the elevator cars 20 must be moved from the start stopping point to the end stopping point within this predetermined time interval. For example, a time interval of eight minutes could be predetermined, that is to say that an elevator car 20 is moved from the start stopping point to the end stopping point of the travel route 30 within these predetermined eight minutes. In particular, there is provision that the same time interval, that is to say for example in each case a time interval of eight minutes, is predetermined for each of the elevator cars 20.

In this exemplary embodiment, there is further provision that specific time points are predetermined at which a respective elevator car 20 makes a planned stop at a respective stopping point 40. These specific time points are chosen to be different for each of the elevator cars 20. Thus, for example, there can be provision that a first elevator car 20 starts at the stopping point 40 illustrated on the bottom left in FIG. 1b at a time point x, then is moved in the arrow direction toward the next stopping point 40 and makes a stop there at a time x+a. The next stopping point 40 is then advantageously entered at a predetermined time point x+a+b. The next stopping point 40 is then entered at a predetermined time point x+a+b+c, etc., until, after a time x+y, the elevator car makes a stop again at the stopping point 40 illustrated on the bottom left of FIG. 1b. The next stop at the next stopping point 40 is then made at the predetermined time point x+y+a. In this way, for each elevator car 20 and for each of the stopping points 40 of the travel route 30, a number of time points are fixed at which a respective elevator car 20 makes a planned stop recurrently at the respective stopping point 40. Here, the time points can be individually fixed for each day of the week. Advantageously, the time offset with which elevator cars 20 travel to a stopping point 40 of the elevator route 30 is fixedly predetermined. This advantageously affords as it were a travel plan of when an elevator car 20 will stop at one of the stopping points 40 or when it will reach a stopping point 40.

Other than when using the elevator cars 21, it is possible in this exemplary embodiment for an elevator user when using an elevator car 20 to advantageously recognize when, for example at the stopping point 40 illustrated at the bottom right in FIG. 1b, he can enter an elevator car 20, that is to say how long he must wait until an elevator car 20 travels to this stopping point 40. Moreover, the elevator user can further recognize when, upon entry into the elevator car 20, he will for example reach the stopping point 40 illustrated at the top right in FIG. 1b using this elevator car.

This information, that is to say in particular when an elevator car 20 stops at which stopping point, is advantageously displayed on a display device 8, which is symbolically illustrated in FIG. 1a, inside and/or outside an elevator car 20. Such a display device 8 is advantageously arranged at least on those floors at which a stopping point 40 of the travel route 30 is fixed.

With reference to FIG. 1a and FIG. 1c, a further exemplary embodiment for operating an elevator system 1 illustrated in FIG. 1a is explained in more detail. In this exemplary embodiment, there is provision that a respective travel route 30, 31, 32, 33, 34, 35, 36 is assigned to all elevator cars 20, 21, 22, 23, 24, 25, 26. Here, the travel route 30 is assigned to a first number of elevator cars 20, the travel route 31 is assigned to a second number of elevator cars 21, the travel route 32 is assigned to a third number of elevator cars 22, the travel route 33 is assigned to a fourth number of elevator cars 23, the travel route 34 is assigned to a fifth number of elevator cars 24, the travel route 35 is assigned to a sixth number of elevator cars 25 and, as travel route, the travel route 36 is assigned to a seventh number of elevator cars 27. Here, the travel routes 30, 31, 32, 33, 34, 35, 36 are each defined by a sequence of stopping points at which the respective elevator cars 20, 21, 22, 23, 24, 25, 26 make a planned stop. For reasons of better clarity, FIG. 1c illustrates by way of example only the fixed stopping points 42 of the travel route 32.

In this exemplary embodiment, fixed times are predetermined in each case for an elevator car 20, 21, 22, 23, 24, 25, 26 at which the latter makes a planned stop at a stopping point. Advantageously, it is thus always unambiguously defined when which elevator car 20, 21, 22, 23, 24, 25, 26 will make a stop at which stopping point of its respective travel route 30, 31, 32, 33, 34, 35, 36. Here, the stopping points can have different distances from one another in dependence on the respective travel route 30, 31, 32, 33, 34, 35, 36. For example, there can be provision that, for the travel route 36, a stopping point is situated on each floor. This is particularly expedient when these floors are highly frequented, for example if businesses are arranged on these floors and a large number of elevator users enter and/or exit an elevator car on each floor level. Moreover, there can in particular be provision that, for example along the travel section which corresponds to the travel route 34, further travel routes are provided (not illustrated in FIG. 1c) that are assigned for example to a subset of the elevator cars 24. Here, the travel route 34 and the further travel route each serve the same travel section, but the travel routes have other stopping points. That is to say that the travel routes are defined by other stopping points and can moreover be defined by other stopping times at the stopping points. Thus, for example, there can be provision that, along the travel section which corresponds to the travel route 34, some of the elevator cars 24 have the odd floors as stopping points and the other elevator cars 24 are allocated the even floors as stopping points.

In the exemplary embodiment explained in relation to FIG. 1a and FIG. 1c, an elevator user is advantageously also provided with a new way of operating the elevator system 1. For this purpose, there is provision that at least one display device 8 is arranged on the respective floors. This is advantageously designed here as a touchscreen. An example of such a display device is illustrated here in FIG. 2. On the display device 8 there is here schematically displayed the elevator system 1 with the correspondingly present travel routes 30, 31, 32, 33, 34, 35, 36. Moreover, there is provision that the position 50 of an elevator user is displayed. If it is directly evident here to the elevator user that his desired destination position 51 is served by elevator cars 22 to which the travel route 32 is allocated, the elevator user can for example select the travel route 32 by touching the latter. As a result, a corresponding travel request of an elevator user is advantageously registered by the elevator controller 6. This results advantageously in an elevator car 22 stopping at the starting position 50, in particular even when the starting position 50 is not a defined stopping point of the travel route 32. It is advantageously indicated here to the elevator user, in an additional display field 60 of the display devices 8 in a departure display 61, when an elevator car 22 will depart at the starting position 50. Moreover, it is advantageously indicated in the arrival display field 62 when the elevator car 22 will reach the destination position 51.

Alternatively or additionally, there can in particular be provision that an elevator user can also directly specify his destination position 52. For this purpose, the elevator user advantageously specifies the destination position 52 by means of the touchscreen on the schematically displayed elevator system 1′. The elevator controller 6 then calculates how the elevator user will best reach the destination position 52 starting from the starting position 50. In the display field 60, it is advantageously indicated to the elevator user that he must first use the travel route 32, with preferably a corresponding arrival time being indicated. Displayed to him in a field 63 is the necessary elevator car change from an elevator car 23 to an elevator car 22 to which the travel route 32 is assigned, in particular together with a preferred change point at which the change from the elevator car 23 to the elevator car 22 occurs. This change point could for example be the stopping point 42 illustrated in FIG. 2 below the starting position 50. This change point is advantageously also displayed in the display field 60. Moreover, the arrival time at the destination position 52 is preferably indicated. In particular, moreover, it can be indicated when an elevator car 23 to which the travel route 33 is assigned will arrive at the stopping point 42 determined as change point, and when an elevator car 22 will arrive at this stopping point 42 for further travel to the destination position 52.

With reference to FIG. 1a and FIG. 1d, a further advantageous aspect for the operation of an elevator system 1, as illustrated in FIG. 1a, will be explained. In FIG. 1d here, the travel route 32 assigned to the elevator cars 22 is illustrated by way of example. In this embodiment, there is now provision for travel requests of elevator users to be detected and for the detected travel requests to be evaluated, preferably using the elevator controller 6. Here, travel requests can be detected for example by means of cameras installed on the floors. Alternatively or in addition, there can be provision that the calls made by elevator users are detected on the floors. If the evaluation reveals that the number of the travel requests has changed, there is in particular provision that the travel route 32 assigned to the elevator cars 22 is adapted to these changed travel requests. In the exemplary embodiment illustrated in FIG. 1d, there can be provision for example that, for the stopping points 42′ or for further stopping locations situated between these stopping points 42′, no volume of persons is detected, for example because no persons are recognized in this building region by means of corresponding cameras installed on the floors, or because this building region is blocked to person traffic. The reason for such blocking can be, for example, the end of the business opening times of businesses situated in this building region. The elevator system 1 or the elevator controller 6 of the elevator system 1 can advantageously react to this by, for example, removing the stopping points 42′ from the travel route 32 and replacing the stopping points 42′ by new stopping points 42″. In particular, there is provision here that, on account of the shortening of the travel route 32 resulting from the replacement of the stopping points 42′, time points at which an elevator car 22 makes a stop at one of the stopping points 42 can also be correspondingly adapted. If the number of persons to be conveyed along the travel route 32 has also reduced with respect to the newly adapted travel route 32, there can moreover in particular be provision that the number of the elevator cars 22 to which the travel route 32 is assigned is reduced. Here, elevator cars 22 to which the travel route 32 is no longer assigned can be moved into a depot region, which is not explicitly illustrated in FIG. 1d. Alternatively, there can be provision for the elevator car to which no travel route is assigned to be temporarily parked in an unused or barely used elevator shaft of the elevator system 1. If the number of persons wishing to be conveyed along the travel route 32 increases again, there is provision that the travel route 32 is again assigned to the parked elevator car. If, by contrast, on account of a locally changed volume of persons along another travel route, there is an increased requirement for transport capacity, for example along the travel route 36, there can in particular also be provision that the travel route 36 is now assigned to the parked elevator car or an elevator car 22. In particular, there can also be provision that a travel route not illustrated in FIG. 1c is assigned as further travel route to this elevator car. Here, travel routes can advantageously be adapted to an existing transport volume while taking the already existing travel routes into consideration, and new stopping points can be defined.

FIG. 3 illustrates a further exemplary embodiment of an elevator system 1. This elevator system 1 comprises two vertical elevator shafts 3 and two horizontal elevator shafts 4, with the result that the elevator cars 20, 21, 22 of the elevator system 1 can be moved counterclockwise in particular in a circulating operation. Moreover, the elevator system 1 comprises a depot region 70 in which elevator cars 22 to which no travel route is assigned are parked. In this exemplary embodiment, a first travel route is assigned to each of the elevator cars 20. A second travel route is assigned to each of the elevator cars 21. Here, the travel route of the elevator cars 20 is defined by the sequence of the stopping points 40. Here, the second travel route to which the elevator cars 21 is assigned is defined by the sequence of the stopping points 41. The two uppermost floors and the two lowermost floors of the elevator system 1 are here stopping points 40, 41 both of the first travel route and of the second travel route. In this exemplary embodiment, there is provision that, for example depending on the time of day, there is a higher conveying requirement from the lower floors to the higher-up floors. As a result of this, a plurality of stopping points 41 in the right vertical elevator shaft 3 are assigned to the elevator cars 21. By contrast, the elevator cars 20 serve uniformly distributed stopping points 40. In particular, there is provision that the stopping points 40, 41 can be defined differently depending on the time of day. In particular, there can be provision that the first travel route with the stopping points 40 or the second travel route with the stopping points 41 can also be assigned to elevator cars 22 situated in the depot 70, depending on the conveying requirement. Moreover, there can be provision that, in the case of a small conveying requirement, elevator cars 20 or elevator cars 21 can be moved into the depot region 70.

The exemplary embodiments illustrated in the figures and explained in relation thereto serve to explain the invention and are not intended to limit it.

### LIST OF REFERENCE SIGNS

1 Elevator system
1′ Display of the elevator system (1) on the display device (8)
3 Vertical elevator shaft
4 Horizontal elevator shaft
6 Elevator controller
8 Display device
20 Elevator car
21 Elevator car
22 Elevator car
23 Elevator car
24 Elevator car
25 Elevator car
26 Elevator car
30 Travel route
31 Travel route
32 Travel route
33 Travel route
34 Travel route
35 Travel route
36 Travel route
40 Stopping point
42 Stopping point
42′ Stopping point (old)
42″ Stopping point (new)
50 Starting position
51 Destination position
52 Destination position
60 Display field
61 Departure display
62 Arrival display
63 Elevator car change display
70 Depot

1.-15. (canceled)

16. A method of operating an elevator system having a plurality of elevator cars that are simultaneously and individually moveable in an elevator shaft between a plurality of floors, the method comprising:
assigning at least one of the plurality of elevator cars to a predetermined travel route, wherein the travel route is defined by a sequence of stopping points that are fixed in advance for the at least one elevator car and at which stopping points the at least one elevator car is to make a planned stop; and
moving the at least one elevator car along the travel route to which it has been assigned.

17. The method of claim 16, wherein the travel route assigned to the at least one elevator car includes a start stopping point, from which the travel route of the at least one elevator car begins, and an end stopping point, at which the travel route of the at least one elevator car ends, the method further comprising:
defining a predetermined time interval over which the at least one elevator car is to move from the start stopping point to the end stopping point during said moving step; and
moving the at least one elevator car from the start stopping point to the end stopping point within the predetermined time interval.

18. The method of claim 16, wherein the predetermined travel route includes a sequence of stopping points, wherein the method further comprises:
recurrently stopping the at least one elevator car at a planned stop at a first stopping point in the sequence of stopping points, at each of a number of predetermined times.

19. The method of claim 16, wherein said assigning step comprises assigning at least two elevator cars to the predetermined travel route, the method further comprising stopping the at least two elevator cars at respectively different times at planned stops located at each of the stopping points in the sequence of stopping points.

20. The method of claim 19, further comprising:
predetermining a minimum interval of time between which a first elevator car makes a planned stop at a first stopping point in the sequence of stopping points, and a second elevator car following the first elevator car makes a planned stop at the first stopping point.

21. The method of claim 19, further comprising:
predetermining respective times at which each of the at least two elevator cars will make a planned stop at each of the respective stopping points in the sequence of stopping points.

22. The method of claim 16, further comprising:
detecting travel requests of elevator users;
evaluating the detected travel requests; and
determining how many of the plurality of elevator cars are assigned to the predetermined travel route based on the evaluation of the travel requests.

23. The method of claim 16, further comprising:
detecting travel requests of elevator users;
evaluating the detected travel requests; and
adapting the travel route assigned to the at least one elevator car based on the result of the evaluation.

24. The method of claim 16, wherein the travel route to be assigned to the at least one elevator car is determined based on at least one of an event occurring in the building in which the elevator is located, the day of the week on which the assigning occurs, behavior of people in the building, weather, time of year, local public transport departure or arrival times, and time of the day.

25. The method of claim 16, further comprising:
displaying the travel route assigned to the at least one elevator car on at least one display device.

26. The method of claim 16, wherein said assigning step comprises assigning a first travel route to a first elevator car, and assigning a second travel route to a second elevator car, the first travel route having a different sequence of stopping points than the second travel route.

27. The method of claim 26, further comprising, after assigning the second travel route to the second elevator car, temporarily assigning the first travel route to the second elevator car.

28. The method of claim 26, further comprising, continuously determining and updating a travel path for a third elevator car from the plurality of the elevator cars, based on call requests received by the elevator system.

29. An elevator controller for operating an elevator system having a plurality of elevator cars that are simultaneously and individually moveable in an elevator shaft between a plurality of floors, the controller comprising:
computer readable and executable instructions configured to:
assign at least one of the plurality of elevator cars to a predetermined travel route, wherein the travel route is defined by a sequence of stopping points that are fixed in advance for the at least one elevator car and at which stopping points the at least one elevator car is to make a planned stop, and
move the at least one elevator car along the travel route to which it has been assigned.

30. An elevator system, comprising:
a shaft system;
a plurality of elevator cars that are movable in the shaft system; and
an elevator controller configured to control movement of the plurality of elevator cars that are simultaneously and individually moveable in the shaft system between a plurality of stopping points in a building, the controller comprising computer readable and executable instructions configured to,
assign at least one of the plurality of elevator cars to a predetermined travel route, wherein the travel route is defined by a sequence of the stopping points that are fixed in advance for the at least one elevator car and at which stopping points the at least one elevator car is to make a planned stop, and
move the at least one elevator car along the travel route to which it has been assigned.
